(19) United States
(12) Patent Application Publication
(10) Pub. No.: US 2011/0314108 A1
(43) Pub. Date: Dec. 22, 2011

(54) DATA MIGRATION BETWEEN DISPARATE DATA STRUCTURES

(76) Inventors: David Desmond, Santa Clara, CA (US); Steven Cento, Cupertino, CA (US)

(21) Appl. No.: 12/821,111

(22) Filed: Jun. 22, 2010

(51) Int. Cl. G06F 17/30; G06F 15/16

(52) U.S. Cl. 709/206; 707/803; 707/E17.032; 707/E17.044

(57) ABSTRACT

A method and apparatus for the data migration between disparate data structures is described herein. In one embodiment, a process is provided to determine information associated with one or more users in a first data structure which may be used to create an account in a second data structure for each of the one or more users in the first data structure. A portion of a first data structure to copy to a second data structure may be determined based on a search of the first data structure in its entirety. A structured view of a mail database associated with at least one of a plurality of mail applications in the first data structure may be created. The structured view may be configured to receive data from each of the plurality of mail applications. A portion of the mail database with the structured view may be streamed to the second data structure and may be used by the second data structure to create one or more files.

### FIELD OF THE INVENTION

The field of invention can relate generally to computing systems, and, more specifically, to data migration between disparate data structures.

### BACKGROUND

Data may exist in a first data structure which is desirable to migrate to a second data structure. For example, when a user purchases or otherwise obtains a new data processing system, the user will often want to move or migrate the data (e.g., emails) from the older system (first data structure) to the newer system (second data structure). However, the first data structure and the second data structure may have disparate structures. Furthermore, the first data structure may store data from multiple applications (e.g., multiple mail client programs) which are not compatible with the second data structure.

### SUMMARY OF THE DESCRIPTION

Mechanisms for data migration between disparate data structures are described herein. In one embodiment, a process can be provided to determine information associated with one or more users in a first data structure created by a first application such as a particular mail client. The information can be used to create an account in a second data structure for each of the one or more users in the first data structure. A determination can be made of a portion of the first data structure to copy to the second data structure based on a search of the first data structure in its entirety. A structured view of a mail database can be created. This structured view can be created using a reader for the particular mail client and its first data structure, and a software architecture can provide a reader for each possible mail client on the first system. The mail database may be associated with at least one of a plurality of mail applications in the first data structure. The structured view can be configured to receive data from each of the plurality of mail applications. A network connection can be used to stream a portion of the mail database with the structure view to the second data structure. The second data structure can create one or more files in the second data structure based on the portion of the mail database. Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates an exemplary system architecture including multiple computer systems connected over a network in which embodiments of the present invention may operate;

FIG. 2 illustrates a block diagram of an exemplary computer system in which embodiments of the present invention may operate;

FIG. 3 illustrates an exemplary memory in accordance with FIG. 2;

FIG. 4 illustrates an alternate exemplary memory in accordance with FIG. 2;

FIG. 5 illustrates a software stack in accordance with embodiments of the present invention;

FIG. 6 illustrates a flow diagram of a data migration method in accordance with embodiments of the present invention; and

FIG. 7 illustrates a flow diagram of an alternate data migration method in accordance with embodiments of the present invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Data can be migrated from disparate data structures. In one embodiment, data migration between disparate data structures can determine user accounts on a first data structure. Equivalent user accounts can be created in the second data structure for each of the user accounts found on the first data structure. A search is performed on the entire first data structure to determine files and/or folders that can be migrated from the first data structure to the second data structure. In one embodiment, the first data structure includes a mail database storing mail data from different mail applications. In this embodiment, a structured view of the mail database can be created. A portion of the mail database with the structured view can be streamed over a network connection to the second data structure. The second data structure can create one or more files in the second data structure based on the portion of the mail database that was streamed.

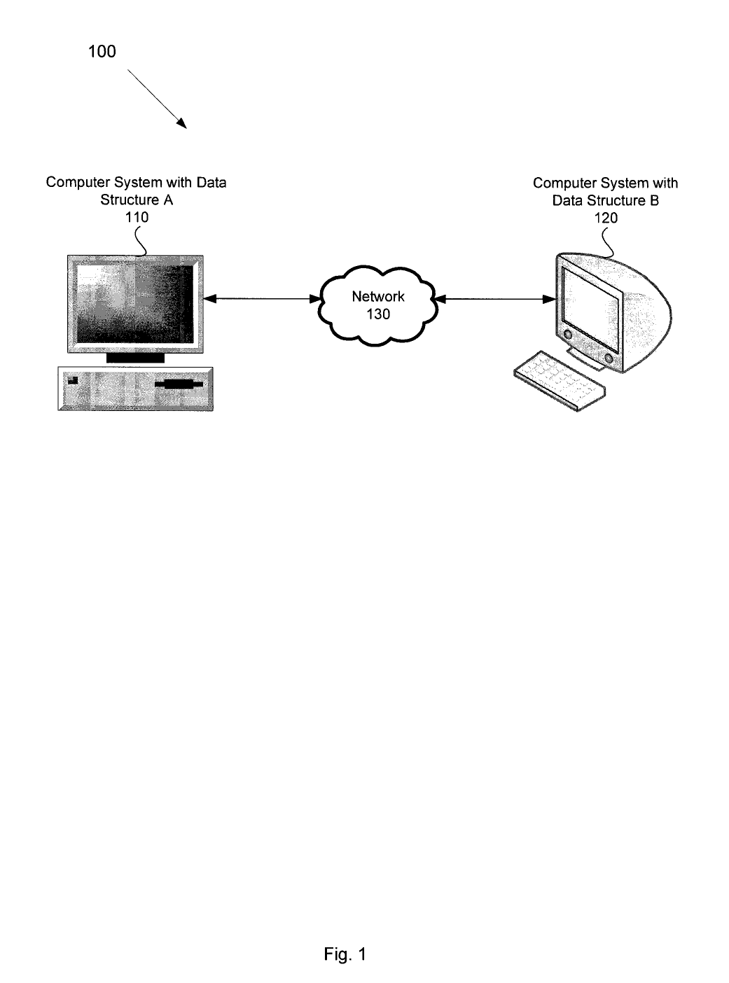

FIG. 1 shows a system architecture 100 in which the data migration between disparate data structures described above may be performed. System architecture 100 includes computer system with data structure A 110 and computer system with data structure B 120. Computer system with data structure A 110 and computer system with data structure B 120 may communicate with each other via network 130. In one embodiment, data structure A within computer system with data structure A 110 may be an operating system. In one embodiment, data structure B within computer system with data structure B may be an operating system which is different than the operating system within computer system with data structure A 110. Data to be migrated from computer system with data structure A 110 may be migrated to computer system with data structure B 120 via network 130. In one embodiment, network 130 may be a public network (e.g., Internet) or a private network (e.g., local area network (LAN)).

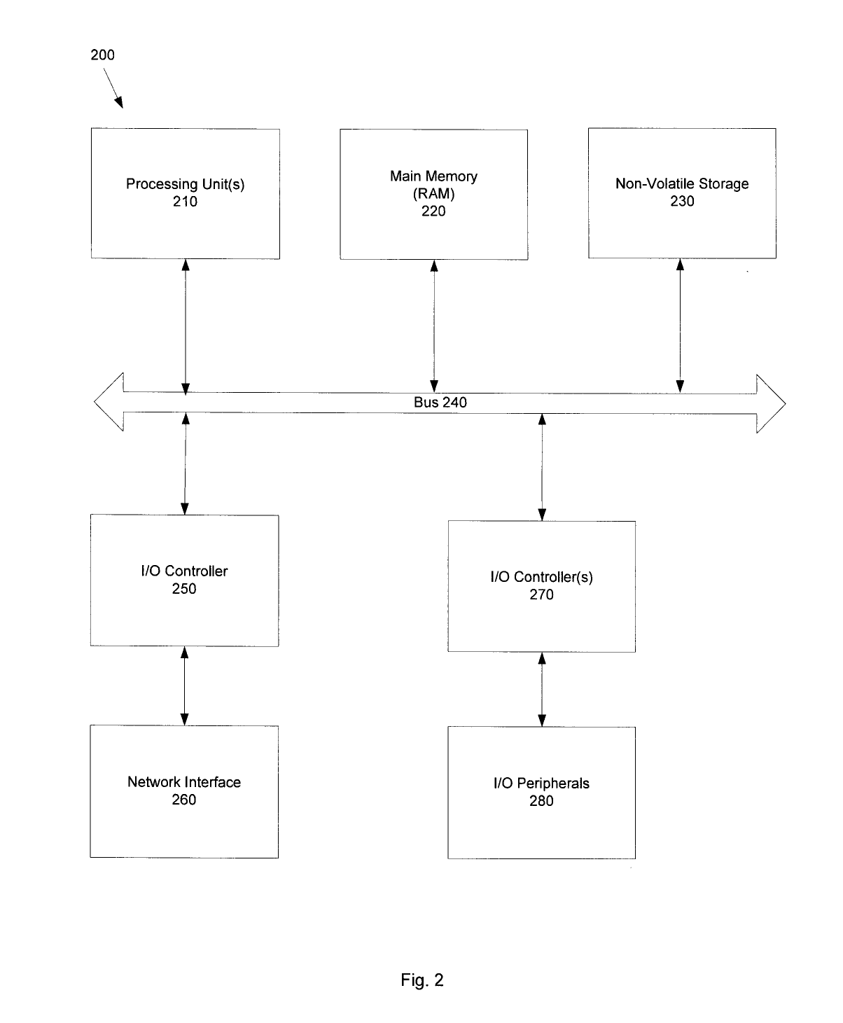

FIG. 2 is a block diagram of an exemplary computer system in which embodiments of the present invention may operate. Computer system 200 includes processing unit(s) 210, main memory (RAM) 220, non-volatile storage 230, bus 240, I/O controller 250, network interface 260, I/O controller 270, and I/O peripherals 280.

Main memory 220 encompasses all volatile or non-volatile storage media, such as dynamic random access memory (DRAM), static RAM (SRAM), or flash memory. Main memory 220 includes storage locations that are addressable by the processing unit(s) 210 for storing computer program code and data structures for data migration between disparate data structures. Such computer program code and data structures also may be stored in non-volatile storage 230. Non-volatile storage 230 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 220. Those skilled in the art will immediately recognize that the term “computer-readable storage medium” or “machine readable storage medium” includes any type of volatile or non-volatile storage device that is accessible by a processor (including main memory 220 and non-volatile storage 230).

Processing unit(s) 210 is coupled to main memory 220 and non-volatile storage 230 through bus 240. Processing unit(s) 210 includes processing elements and/or logic circuitry configured to execute the computer program code and manipulate the data structures. It will be apparent to those skilled in the art that other processing and memory means, including various computer readable storage media, may be used for storing and executing computer program code pertaining to data migration between disparate data structures.

Processing unit(s) 210 can retrieve instructions from main memory 220 and non-volatile storage 230 via bus 240 and execute the instructions to perform operations described below. Bus 240 is coupled to I/O controller 250. I/O controller 250 is also coupled to network interface 260. Network interface 260 can connect to a network to migrate data between disparate data structures.

Bus 240 is further coupled to I/O controller(s) 270. I/O controller(s) 270 are coupled to I/O peripherals 280, which may be mice, keyboards, modems, disk drives, optical drives, printers and other devices which are well known in the art.

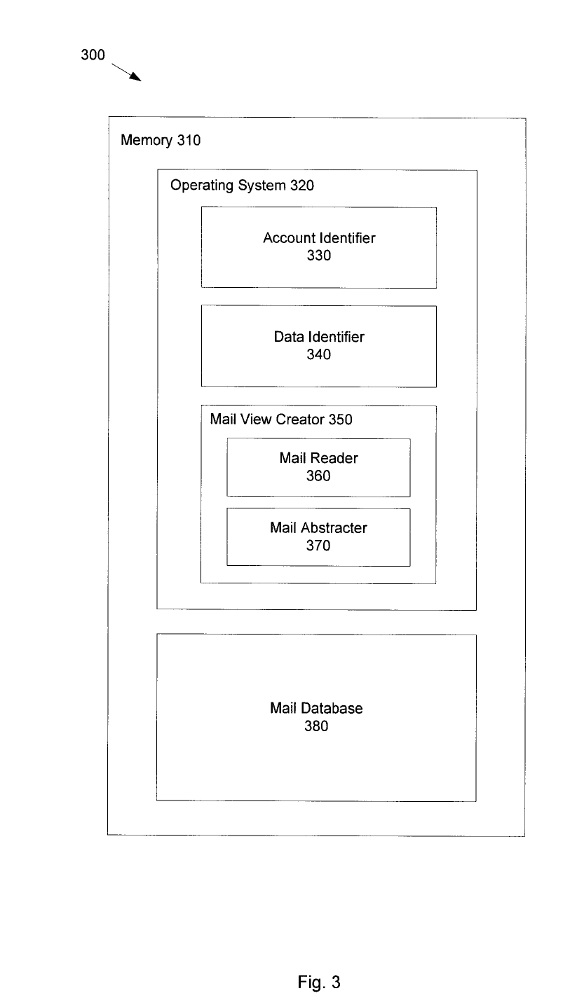

FIG. 3 illustrates an exemplary main memory 220 of FIG. 2. Referring to FIG. 3, memory 310 contains operating system 320 and mail database 380. Within operating system 320, there is account identifier 330, data identifier 340, and mail view creator 350. Within mail view creator 350, there is mail reader 360 and mail abstracter 370. In other embodiments, the software components 330, 340, 350, 360, and 370 can be separate from and not part of an operating system. Although memory 310 has been shown as a single memory, this is just one illustrative embodiment. In alternate embodiments, memory 310 can be split into more than one memory.

Account identifier 330 can identify one or more user accounts in a first data structure. In one embodiment, account identifier 330 can identify one or more user accounts in operating system 320. In an alternate embodiment, account identifier 330 can identify one or more user accounts in a data structure (not shown) located outside of operating system 320.

Data identifier 340 can determine a portion of data to migrate from a first data structure to a second data structure. Data identifier 340 can determine the portion of data to migrate by searching the first data structure. In one embodiment, data identifier 340 can identify data in memory 310 to migrate. In an alternate embodiment, data identifier 340 can identify data from outside of memory 310, such as from a disk drive (not shown). In one embodiment, data identifier 340 can search the first data structure in its entirety. In one embodiment, data identifier 340 may not search at least a portion of the first data structure stored in one or more folders. For example, in one embodiment, data identifier 340 may determine that folder “My Pictures” in the first data structure is to be migrated to the second data structure. Data identifier 340 may not need to search folder “My Pictures” to determine which underlying files should be migrated and may instead choose to migrate the entire “My Pictures” folder. In one embodiment, data identifier 340 may identify data to migrate from the first data structure to the second data structure which is not compatible with the second data structure. In this embodiment, the identified data can still be migrated to the second data structure. In one embodiment, notification to a user may not be required prior to migrating the identified data from the first data structure to the second data structure. In an alternate embodiment, the identified data from the first data structure may be presented to a user for selection prior to migrating the identified data. In this embodiment, only the portion of the identified data which is selected by the user can be migrated to the second data structure.

In one embodiment, data identifier 340 can further identify a hierarchy of the first data structure. In one embodiment, the hierarchy of the first data structure can be different than the hierarchy of the second data structure to which to migrate the identified data. In this embodiment, data identifier 340 can create a mapping of the hierarchy of the second data structure to the hierarchy of the first data structure.

Mail view creator 350 can create a structured view of mail data stored in a mail database. In one embodiment, the mail database is mail database 380. In one embodiment, mail view creator 350 can include mail reader 360 and mail abstracter 370. Mail reader 360 can include a data reader for each of a plurality of mail applications supported by the first data structure. In one embodiment, mail reader 360 can include a single data reader for all of the plurality of mail applications supported by the first data structure. In one embodiment, mail applications supported by mail view creator 350 include Windows Mail, Windows Live Mail, Outlook, and Outlook Express. In one embodiment, each data reader within mail reader 360 can read mail data that is associated with the data reader's mail application. For example, in one embodiment, mail reader 360 can include a data reader for Windows Mail which reads the portion of a mail database which corresponds to data for Windows Mail. In one embodiment, mail reader 360 can read mail data from mail database 380. In an alternate embodiment, mail data can be read from a location outside of memory 310, such as an external disk (not shown). In one embodiment, mail reader 360 can send mail data read from the mail database to mail abstracter 370. In addition, in one embodiment, once the mail data is read by mail reader 360, a completion notice can be sent from mail reader 360 to mail abstracter 370 that all read mail data has been sent.

Mail abstracter 370 can abstract mail data received from mail reader 360. In one embodiment, mail abstracter 370 can abstract mail data to create a structured view of the mail data. In one embodiment, mail abstracter 370 can abstract the mail data by creating a reference to a portion of the mail data. In one embodiment, a reference is created for all portions of the mail data. In one embodiment, a reference can be used to provide a stream handle to a portion of the mail data. In one embodiment, a portion of the mail data may not be a file, but may appear to be a file to a second data structure. In one embodiment, the structured view of the mail data may not include passwords stored in the mail database. In one embodiment, once mail abstracter 370 abstracts the mail data, mail abstracter 370 can stream the structured view of the mail data to a second data structure. In one embodiment, mail abstracter 370 can stream the structured view of the mail data to the second data structure by interpreting a reference to the mail data along with the portion of the mail data corresponding to the reference. In one embodiment, once mail abstracter 370 abstracts the mail data, mail abstracter 370 can send a notification to mail view creator 350 to inform mail view creator 350 that the structured view has been created. In this embodiment, upon receiving the notification from mail abstracter 370, mail view creator 350 can stream the structured view to a second data structure. In one embodiment, mail view creator 350 can stream the structured view of the mail data to the second data structure by interpreting a reference to the mail data along with the portion of the mail data corresponding to the reference.

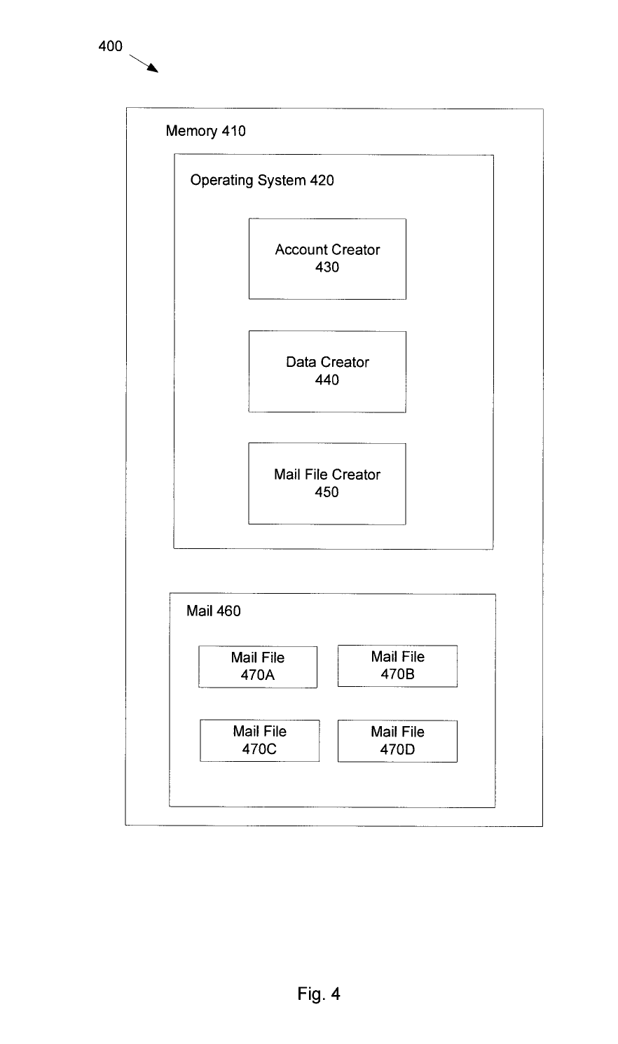

FIG. 4 illustrates an alternate exemplary main memory 220 of FIG. 2. Referring to FIG. 4, memory 410 contains operating system 420 and mail 460. Within operating system 420, there is account creator 430, data creator 440, and mail file creator 450. Within mail 460, there is mail file 470A, mail file 470B, mail file 470C, and mail file 470D. In other embodiments, the software components 430, 440, and 450 can be separate from and not part of an operating system. Although memory 410 has been shown as a single memory, this is just one illustrative embodiment. In alternate embodiments, memory 410 can be split into more than one memory.

Account creator 430 can create one or more user accounts on a second data structure based on data received associated with a first data structure. In one embodiment, the information can be obtained from account identifier 330 of FIG. 3. In an alternate embodiment, the information can be received from one or more application programming interface (API) calls made by account creator 430 to a first data structure. In one embodiment, account creator 430 can create a user account in the second data structure for each user account in the first data structure.

Data creator 440 can create a hierarchy in a second data structure and store a portion of data migrated from a first data structure in the second data structure based on the created hierarchy. In one embodiment, the second data structure can be memory 410. In an alternate embodiment, the second data structure can be located in an external memory (not shown). In one embodiment, the portion of data migrated can be identified by data identifier 340 of FIG. 3. In an alternate embodiment, the portion of data to be stored in memory 410 can be received from one or more API calls made by data creator 440 to a first data structure. In one embodiment, along with the portion of data migrated, data creator 440 can receive information about a hierarchy of the first data structure. In one embodiment, the hierarchy of the first data structure can be different than an existing hierarchy of the second data structure. In one embodiment, data creator 440 may map the hierarchy of the second data structure to the hierarchy of the first data structure. Data creator 440 may store the portion of data in the second data structure.

In one embodiment, data creator 440 can determine the size of individual files and/or folders within the portion of data migrated from a first data structure, as well as the overall size of the portion of data migrated. In one embodiment, data creator 440 can determine the size from information received from one or more API calls made to the first data structure. In one embodiment, notification to a user may not be required prior to storing the portion of data migrated from the first data structure in the second data structure. In an alternate embodiment, a user may be notified prior to storing the portion of data migrated from the first data structure in the second data structure. In this embodiment, the user can select the location in the second data structure in which to store the portion of data.

Mail file creator 450 can receive a structured view of mail data and create one or more files in a second data structure based on the structured view of mail data. In one embodiment, the second data structure can include mail 460. In an alternate embodiment, the second data structure can be external to memory 410. In one embodiment, the structured view of mail data received by mail file creator 450 can be created by mail view creator 350 of FIG. 3. In an alternate embodiment, the portion structured view of mail data can be received from one or more API calls made by mail file creator 450 to a first data structure.

In one embodiment, mail file creator 450 can receive a data stream of the structured view of mail data and can create a mail file based on the streamed data. In one embodiment, a mail file can be created for each of a plurality of mail applications supported by a first data structure. In one embodiment, mail applications supported by mail file creator 450 can include Windows Mail, Windows Live Mail, Outlook, and Outlook Express. In one embodiment, the second data structure supports different mail applications than the mail applications supported by the first data structure.

In one embodiment, prior to creating a mail file, mail file creator 450 can determine the size of the streamed version of the structured view of mail data. In one embodiment, mail file creator 450 can determine the size by making one or more API calls to the first data structure. In one embodiment, mail file creator 450 can determine the size prior to receiving the streamed version of the structured view of mail data.

Mail 460 contains mail files 470A, 470B, 470C, and 470D. In one embodiment, mail file creator 450 can create file 470A for mail application A, mail file 470B for mail application B, mail file 470C for mail application C, and mail file 470D for mail application D.

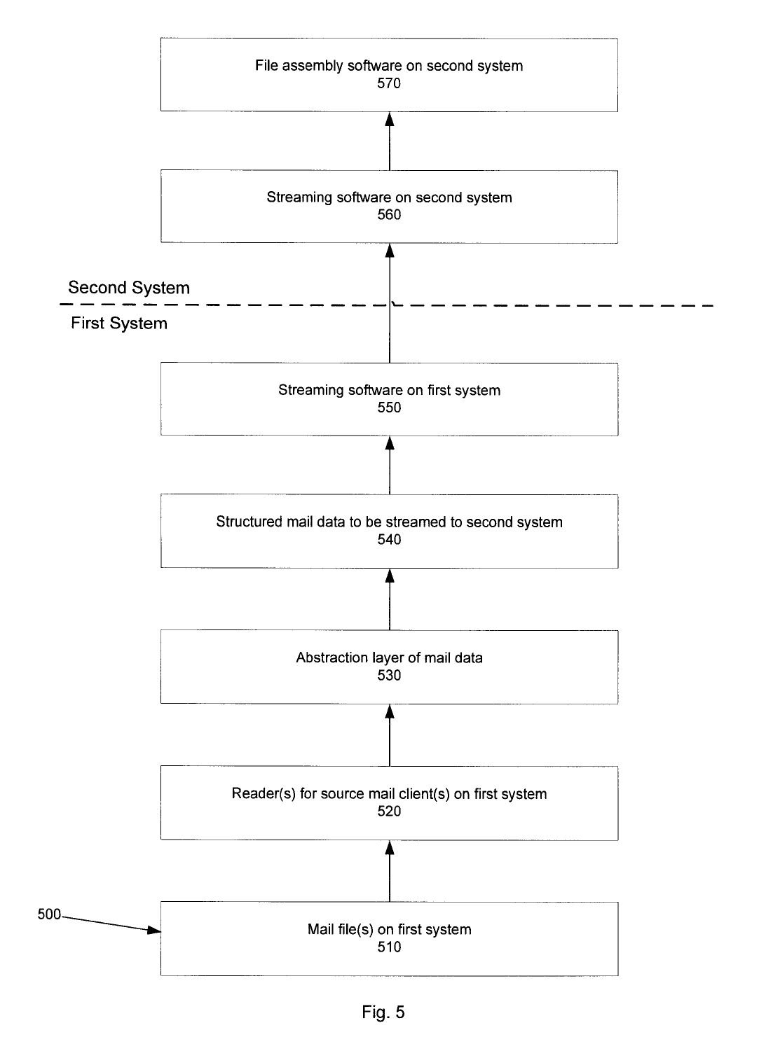

FIG. 5 illustrates an exemplary software stack in accordance with embodiments of the present invention. Referring to FIG. 5, software stack 500 starts in a first system at block 510, which stores one or more mail files on the first system. Mail file(s) on first system 510 can include multiple mail files, including email files or databases. Mail file(s) on first system 510 can be for multiple mail clients. Mail file(s) on first system 510 can be sent to reader(s) for source mail client(s) on first system 520. Reader(s) for source mail client(s) on first system 520 can include a reader for each source mail client on the first system. Each file in mail file(s) on first system 510 can be read by a reader chosen from reader(s) for source mail client(s) on first system 520. The chosen reader can correspond to the mail client that created the mail file.

Abstraction layer of mail data 530 can abstract mail data received from reader(s) for source mail client(s) on first system 520 to create structured mail data to be streamed to second system 540. Abstraction layer of mail data 530 can create structured mail data to be streamed to second system 540 by creating a reference to each portion of the mail data received. In one embodiment, a reference can be used to provide a stream handle to a portion of the mail data received.

Streaming software on first system 550 can stream structured mail data to be streamed to second system 540 from the first system to a second system. In one embodiment, the streaming can be performed over a network between the first system and the second system. Streaming software on second system 560 can receive structured mail data to be streamed to second system 540 from streaming software on first system 550. Streaming software on second system 560 can send the received structured mail data to file assembly software on second system 570. File assembly software on second system 570 can receive the structured mail data and assemble the mail data into one or more files.

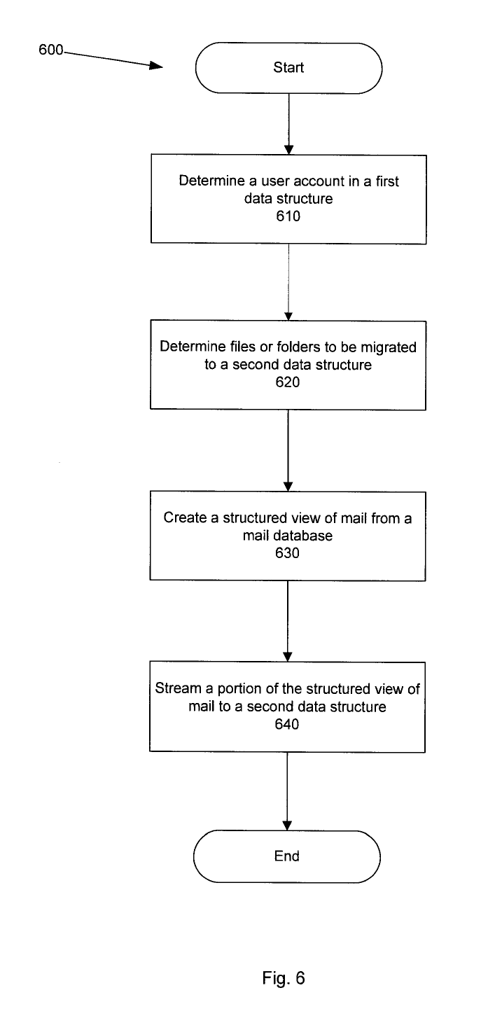

FIG. 6 illustrates an exemplary flow diagram of a data migration method in accordance with embodiments of the present invention. In one embodiment, data migration method 600 is performed by account identifier 330, data identifier 340, and mail view creator 350 of FIG. 3. In an alternate embodiment, data migration method 600 is performed by account creator 430, data creator 440, and mail file creator 450 of FIG. 4 through API calls made to a first data structure.

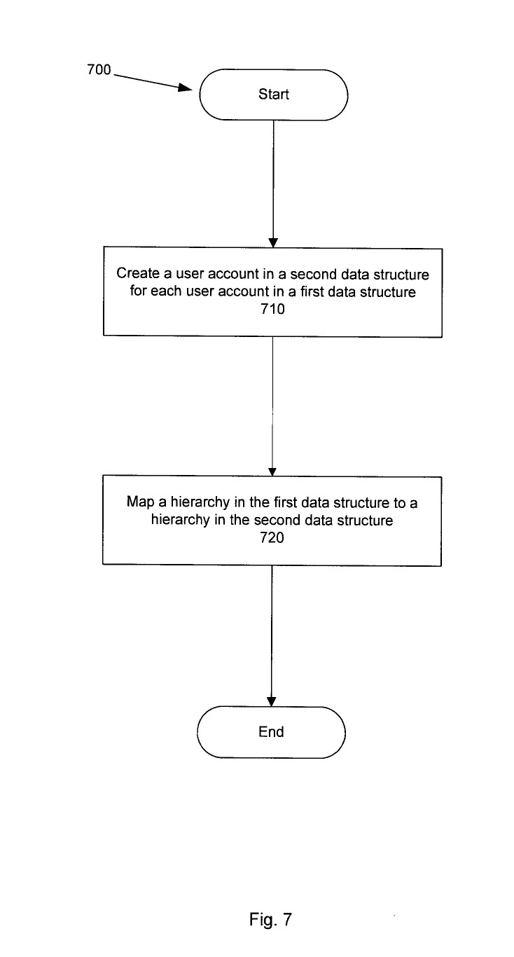

Referring to FIG. 6, method 600 starts at block 610 to determine a user account in a first data structure. In one embodiment, the first data structure can be a first system, such as a computer system. In one embodiment, a user account can be determined by searching for account information in a specific part of the first data structure. In an alternate embodiment, a user account can be determined by information returned by one or more API calls made to the first data structure. In one embodiment, once a user account in a first data structure is determined, an equivalent user account can be created in a second data structure. In one embodiment, the second data structure has a different structure than the first data structure. The creation of equivalent user accounts is described below in conjunction with FIG. 7. The process then proceeds to block 620.

At block 620, a determination is made of data, which may include one or more files or folders, to be migrated from the first data structure to the second data structure. In one embodiment, the data to be migrated can be determined by searching the first data structure. In one embodiment, the entire first data structure can be searched in order to determine the data to be migrated. In one embodiment, the first data structure may have a hierarchy for data stored in the first data structure. In one embodiment, the second data structure may have a hierarchy for data stored in the second data structure which is different than the hierarchy of the first data structure. In this embodiment, hierarchy information for the first data structure can be included with the data to be migrated such that the hierarchy of the second data structure can be mapped to the hierarchy of the first data structure. Mapping of the hierarchy of the second data structure to the hierarchy of the first data structure is described below in conjunction with FIG. 7.

In one embodiment, a portion of the first data structure stored in one or more folders may not be searched. For example, in one embodiment, the folder “My Pictures” can be determined as a folder in the first data structure to be migrated to the second data structure. In this embodiment, the process may not need to search the contents of “My Pictures” to determine which underlying files should be migrated. Instead, in this embodiment, the process can migrate the entire “My Pictures” folder to the second data structure. In one embodiment, the data to be migrated from the first data structure may not be compatible with the second data structure. In this embodiment, the data to be migrated can still be migrated to the second data structure. In one embodiment, notification to a user may not be required prior to migrating data from the first data structure to the second data structure. In an alternate embodiment, the data to be migrated to the second data structure may be presented to a user for selection prior to migrating the data. In this embodiment, only the portion of the data to be migrated which is selected by the user can be migrated to the second data structure. In one embodiment, once the data to be migrated to the second data structure is determined, the data can be migrated to the second data structure. In one embodiment, migrating the data may include copying the data from the first data structure to the second data structure. In one embodiment, the data can be migrated over a network. The process then proceeds to block 630.

At block 630, a structured view of mail from a mail database is created. In one embodiment, mail database includes data from a plurality of mail applications supported by the first data structure. In one embodiment, the mail applications can include Windows Mail, Windows Live Mail, Outlook, and Outlook Express. In one embodiment, the mail applications supported by the first data structure are different than the mail applications supported by the second data structure. In one embodiment, the structured view of mail from the mail database can be created using a two-step process: (1) reading mail data stored for each of the mail applications supported by the first data structure and (2) abstracting the read mail data to create a structured view of the mail data.

In one embodiment, reading mail data stored for each of the mail applications supported by the first data structure can be performed by a mail reader. In one embodiment, a single mail reader can read mail data for all of the mail application supported by the first data structure. In an alternate embodiment, a mail reader can be required for each mail application supported in the first data structure. The mail reader for a mail application can read the mail data from the database which corresponds to the mail application it supports. For example, in one embodiment, a mail reader for Windows Mail reads the portion of mail data from the mail database which corresponds to mail data for Windows Mail.

In one embodiment, once the mail data is read from the mail database, the mail data can be abstracted to create a structured view of the mail data. In one embodiment, mail data can be abstracted by creating a reference to each portion of the mail data. In one embodiment, a reference can be used to provide a stream handle to a portion of the mail data. In one embodiment, a portion of the mail data may not be a file, but may appear to be a file to a second data structure. In one embodiment, the structured view of the mail data may not include passwords stored in the mail database. The process then proceeds to block 640.

Block 640 streams a portion of the structured view of mail data to a second data structure. In one embodiment, the streaming can be performed over a network between the first data structure and the second data structure. In one embodiment, the structured view of the mail data is streamed to the second data structure by interpreting a reference to the mail data along with the portion of the mail data corresponding to the reference. The process then ends.

Method 600 illustrates one implementation of data migration between disparate data structures. In alternate embodiments, the order in which the blocks of method 600 are performed can be modified without departing from the scope of the invention. In one embodiment, method 600 can determine a user account in a first data structure and then determine files or folders to be migrated to a second data structure, following by creating and streaming a structured view of mail from a mail database. In an alternate embodiment, method 600 can determine files or folders to be migrated to a second data structure prior to determining a user account in the first data structure. In an alternate embodiment, method 600 can first create a structured view of mail from the mail database and stream the structured view prior to determining a user account or determining files or folders to be migrated.

FIG. 7 illustrates a flow diagram of data migration between disparate data structures. In one embodiment, data migration method 700 is performed by account creator 430, data creator 440, and mail file creator 450 of FIG. 4.

Referring to FIG. 7, block 710 creates a user account in a second data structure for each user account in a first data structure. In one embodiment, information about each user account in the first data structure can be received from the first data structure. In one embodiment, the information can be received from one or more application programming interface (API) calls made to a first data structure. In one embodiment, a user account can be created by storing an identifier for the user account in the second data structure and associating any information about the user account with the user account. The process then proceeds to block 720.

At block 720, a hierarchy in a second data structure is mapped to a hierarchy in the first data structure. In one embodiment, the hierarchy of the first data structure can be sent from the first data structure to the second data structure. In an alternate embodiment, the hierarchy of the first data structure may be received from one or more API calls made to the first data structure. In one embodiment, mapping the hierarchy of the second data structure to the hierarchy of the first data structure can include creating a hierarchy in the second data structure corresponding (e.g., equivalent to) to the hierarchy of the first data structure. For example, the hierarchy of the first data structure may contain a folder called “My Documents” which may contain the sub-folders “My Videos,” “My Pictures,” and “My Music.” In this example, a folder called “My Documents” may be created in the hierarchy of the second data structure with the sub-folders “My Videos,” “My Pictures,” and “My Music.”

In one embodiment, creating the mapping may further include migrating the data within the hierarchy of the first data structure to the hierarchy of the second data structure. Referring to the previous example, in one embodiment, the files in “My Documents” migrated from the first data structure could be stored in “My Documents” in the second data structure. In this embodiment, the data to be migrated from the first data structure which may be incompatible with data in the second data structure. In this embodiment, the data to be migrated can still be migrated to the second data structure. In one embodiment, notification to a user may not be required prior to migrating data from the first data structure to the second data structure. In an alternate embodiment, the data to be migrated to the second data structure may be presented to a user for selection prior to migrating the data. In this embodiment, only the portion of the data to be migrated which is selected by the user can be migrated to the second data structure.

In one embodiment, block 720 can further create one or more files in a second data structure based on a structured view of mail data streamed from a first data structure. In one embodiment, the structured view of mail data can be received from the first data structure. In an alternate embodiment, the structured view of mail data can be obtained from one or more API calls made to the first data structure. In one embodiment, prior to creating a mail file, the size of the streamed version of the structured view of mail data may be determined. In one embodiment, the size can be determined by making one or more API calls to the first data structure. In one embodiment, a mail file can be created in the second data structure for each mail application supported by the first data structure. In one embodiment, mail applications supported by the first data structure can include Windows Mail, Windows Live Mail, Outlook, and Outlook Express. In one embodiment, the second data structure supports different mail applications than the mail applications supported by the first data structure. In one embodiment, the file can be created by reading a portion of the structured view of the mail data which corresponds to the mail application and storing that portion in the file. The process then ends.

Method 700 illustrates one implementation of data migration between disparate data structures. In alternate embodiments, the order in which the blocks of method 700 are performed can be modified without departing from the scope of the invention. In one embodiment, method 700 can create a user account in a first data structure prior to mapping a hierarchy in the second data structure to a hierarchy in the first data structure. In an alternate embodiment, method 700 can first map the hierarchy in the second data structure to a hierarchy in the first data structure prior to creating a user account in the second data structure.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 600 and 700 in FIG. 6 and FIG. 7 respectively without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method for data migration between disparate data structures comprising:
determining, by a data processing system, information associated with one or more users in a first data structure, wherein the information is used to create an account in a second data structure for each of the one or more users corresponding to the one or more users in the first data structure;
determining a portion of the first data structure to copy to the second data structure based on a search of the first data structure in its entirety;
creating a structured view of a mail database associated with at least one of a plurality of mail applications in the first data structure, wherein the structured view is configured to receive data from each of the plurality of mail applications; and
streaming, over a network connection, a portion of the mail database with the structured view to the second data structure, wherein the second data structure creates one or more files in the second data structure based on the portion of the mail database.

2. The method of claim 1, wherein creating the structured view further comprises:
reading the mail database; and
abstracting a portion of the mail database for each of the plurality of mail applications, wherein the structure view is configured to handle all of the plurality of mail applications if present.

3. The method of claim 1, wherein the search of the first data structure does not search at least a portion of data stored in folders existing in the first data structure.

4. The method of claim 1, wherein the portion of the first data structure to copy comprises data which is not compatible with the second data structure, and wherein a copy is made to the second data structure without notifying a user.

5. The method of claim 1, wherein the portion of the mail database does not include one or more passwords stored in the database.

6. The method of claim 1, wherein the second data structure makes application programming interface (API) calls to the first data structure.

7. The method of claim 1, wherein the first data structure contains a reader for each of the plurality of mail applications, wherein a reader is used to read a subset of the portion of the mail database belonging to the corresponding mail application.

8. A computer-implemented method for data migration between disparate data structures comprising:
creating, by a data processing system, a user account in a second data structure for each of one or more users in a first data structure based on information associated with the one or more users in the first data structure, wherein the first data structure has a hierarchy which is different than a hierarchy of the second data structure; and
mapping the hierarchy in the second data structure to the hierarchy in the first data structure based on data received from the first data structure.

9. The method of claim 8, wherein the mapping includes files from the first data structure that are not compatible with the files in the second data structure.

10. The method of claim 8, wherein the mapping is performed without notifying a user.

11. The method of claim 8, further comprising:
creating a plurality of files based on a portion of a mail database received from the first data structure, wherein the portion of the mail database is transferred, through a connection, as streamed data.

12. A computer-readable storage medium comprising executable instructions to cause a processor to perform operations for error detection during installation of software from an optical disk to a computer, the instructions comprising:
determining, by a data processing system, information associated with one or more users in a first data structure, wherein the information is used to create an account in a second data structure for each of the one or more users corresponding to the one or more users in the first data structure;
determining a portion of the first data structure to copy to the second data structure based on a search of the first data structure in its entirety;
creating a structured view of a mail database associated with at least one of a plurality of mail applications in the first data structure, wherein the structured view is configured to receive data from each of the plurality of mail applications; and
streaming, over a network connection, a portion of the mail database with the structured view to the second data structure, wherein the second data structure creates one or more files in the second data structure based on the portion of the mail database.

13. The computer-readable storage medium of claim 12, wherein the instructions further comprise:
reading the mail database; and
abstracting a portion of the mail database for each of the plurality of mail applications, wherein the structure view is configured to handle all of the plurality of mail applications if present.

14. The computer-readable storage medium of claim 12, wherein the portion of the first data structure to copy comprises data which is not compatible with the second data structure, and wherein a copy is made to the second data structure without notifying a user.

15. The computer-readable storage medium of claim 12, wherein the second data structure makes application programming interface (API) calls to the first data structure.

16. The computer-readable storage medium of claim 12, wherein the first data structure contains a reader for each of the plurality of mail applications, wherein a reader is used to read a subset of the portion of the mail database belonging to the corresponding mail application.

17. A computer-readable storage medium comprising executable instructions to cause a processor to perform operations for error detection during installation of software from an optical disk to a computer, the instructions comprising:
creating, by a data processing system, a user account in a second data structure for each of one or more users in a first data structure based on information associated with the one or more users in the first data structure, wherein the first data structure has a hierarchy which is different than a hierarchy of the second data structure; and
mapping the hierarchy in the second data structure to the hierarchy in the first data structure based on data received from the first data structure.

18. The computer-readable storage medium of claim 17, wherein the mapping includes files from the first data structure that are not compatible with the files in the second data structure.

19. The computer-readable storage medium of claim 17, wherein the instructions further comprise:
creating a plurality of files based on a portion of a mail database received from the first data structure, wherein the portion of the mail database is transferred, through a connection, as streamed data.

20. An apparatus comprising:
means for determining, by a data processing system, information associated with one or more users in a first data structure, wherein the information is used to create an account in a second data structure for each of the one or more users corresponding to the one or more users in the first data structure;
means for determining a portion of the first data structure to copy to the second data structure based on a search of the first data structure in its entirety;
means for creating a structured view of a mail database associated with at least one of a plurality of mail applications in the first data structure, wherein the structured view is configured to receive data from each of the plurality of mail applications; and
means for streaming, over a network connection, a portion of the mail database with the structured view to the second data structure, wherein the second data structure creates one or more files in the second data structure based on the portion of the mail database.

21. The apparatus of claim 20, further comprising:
means for reading the mail database; and
means for abstracting a portion of the mail database for each of the plurality of mail applications, wherein the structure view is configured to handle all of the plurality of mail applications if present.

22. The apparatus of claim 21, further comprising:
means for creating, by a data processing system, a user account in a second data structure for each of one or more users in a first data structure based on information associated with the one or more users in the first data structure, wherein the first data structure has a hierarchy which is different than a hierarchy of the second data structure; and
means for mapping the hierarchy in the second data structure to the hierarchy in the first data structure based on data received from the first data structure.

23. An apparatus comprising:
means for creating, by a data processing system, a user account in a second data structure for each of one or more users in a first data structure based on information associated with the one or more users in the first data structure, wherein the first data structure has a hierarchy which is different than a hierarchy of the second data structure; and
means for mapping the hierarchy in the second data structure to the hierarchy in the first data structure based on data received from the first data structure.

24. The apparatus of claim 21, further comprising:
means for creating a plurality of files based on a portion of a mail database received from the first data structure, wherein the portion of the mail database is transferred, through a connection, as streamed data.

25. A computer system comprising:
a memory; and
a processor configurable by instructions stored in the memory to:
determine, by a data processing system, information associated with one or more users in a first data structure, wherein the information is used to create an account in a second data structure for each of the one or more users corresponding to the one or more users in the first data structure;
determine a portion of the first data structure to copy to the second data structure based on a search of the first data structure in its entirety;
create a structured view of a mail database associated with at least one of a plurality of mail applications in the first data structure, wherein the structured view is configured to receive data from each of the plurality of mail applications; and
stream, over a network connection, a portion of the mail database with the structured view to the second data structure, wherein the second data structure creates one or more files in the second data structure based on the portion of the mail database.

26. A computer system comprising:
a memory; and
a processor configurable by instructions stored in the memory to:
create, by a data processing system, a user account in a second data structure for each of one or more users in a first data structure based on information associated with the one or more users in the first data structure, wherein the first data structure has a hierarchy which is different than a hierarchy of the second data structure; and
map the hierarchy in the second data structure to the hierarchy in the first data structure based on data received from the first data structure.
